(19) United States
(12) Patent Application Publication
(10) Pub. No.: US 2018/0121237 A1
(43) Pub. Date: May 3, 2018

(54) LIFE CYCLE MANAGEMENT OF VIRTUALIZED STORAGE PERFORMANCE

(71) Applicant: Nutanix, Inc., San Jose, CA (US)

(72) Inventors: Bryan Jeffrey Crowe, Santa Clara, CA (US); Satyam B. Vaghani, San Jose, CA (US); Akhilesh Joshi, Sunnyvale, CA (US); Shyan-Ming Perng, Campbell, CA (US); Snehal Mundle, Santa Clara, CA (US); Chethan Kumar, San Jose, CA (US); Sandeep Reddy Goli, San Jose, CA (US); Prashant Saxena, San Jose, CA (US)

(21) Appl. No.: 15/792,710

(22) Filed: Oct. 24, 2017

Related U.S. Application Data
(60) Provisional application No. 62/413,921, filed on Oct. 27, 2016.

(51) Int. Cl. G06F 9/48; G06F 3/06; G06F 12/0813

(52) U.S. Cl. CPC G06F 9/4843; G06F 3/0613; G06F 3/0653; H04L 67/10; G06F 12/0813; G06F 2212/60; G06F 2212/62; G06F 3/067

(57) ABSTRACT

Performance of a virtual machine system is improved by avoiding and/or eliminating bottlenecks in read and write operations. The system analyzes current virtualized workloads and provides working set estimates for individual VMs, hosts, and clusters. The working set estimate data is then utilized to make specific recommendations for different types of backend storage technologies. After procuring a storage device, the system provides a variety of information to aid in the operation of the system. From this information, the system can detect various scenarios and proactively make recommendations to the user about ways in which to improve storage performance at a host level and at a per-VM level. In some embodiments, these recommendations may be implemented automatically without user involvement.

This application claims priority from Provisional Application No. 62/413,921, filed Oct. 27, 2016, which is incorporated by reference herein in its entirety.

### FIELD OF THE INVENTION

The present invention relates generally to storage resource management in computing systems and more specifically to methods to improve such resource management.

### BACKGROUND OF THE INVENTION

Certain computing architectures include a set of computing systems coupled through a data network to a set of storage systems. The computing systems provide computation resources and are typically configured to execute applications within a collection of virtual machines (hereafter “VMs”). The storage systems are typically configured to present storage resources (e.g., storage blocks, logical unit numbers, storage volumes, file systems, etc.) to a host executing the virtual machines.

A given virtual machine can access storage resources residing on one or more storage systems thereby contributing to overall performance utilization for each storage system. Furthermore, a collection of virtual machines can present access requests that stress available performance utilization for one or more of the storage systems, leading to performance degradation. Such performance degradation can negatively impact proper execution of one or more of the virtual machines.

System operators conventionally provision different storage resources manually or automatically on available storage systems, with a general goal of avoiding performance degradation. Provisioning a storage resource typically involves allocating physical storage space within a selected storage system, creating an identity for the storage resource, and configuring a path for the identified storage resource between the storage system and a storage client. Exemplary identities include a logical unit number (LUN) and a file system universal resource locator (URL).

Conventional techniques commonly fail to address performance utilization and overutilization issues associated with the storage systems. Consequently, such techniques fail to optimize performance utilization scenarios and prevent performance degradation. What is needed therefore is an improved technique for automatically managing virtualized storage performance.

### SUMMARY

Disclosed herein is an improved technique for automatically managing virtualized storage performance so as to detect and prevent bottlenecks in read and write operations in virtualized machines.

According to various embodiments, a method of life cycle management of memory resources in a data center containing a plurality of virtual machines running on one or more hosts in one or more clusters is disclosed comprising: procuring, by a processor, one or more storage devices for each virtual machine by, for each virtual machine: measuring, by the processor, the total amount of data written and read by the virtual machine over a specified sizing interval; calculating, by the processor, a Write working data set that is the total amount of data written to memory by the virtual machine over the specified sizing interval; calculating, by the processor, a Read working data set that is the total amount of data accessed by the virtual machine from persistent storage over the sizing interval; determining, by the processor, whether the Read working data set is greater than either an actual resource usage by the virtual machine or a size of a virtual disk associated with the virtual machine and, if so, setting the Read working data set to be the size of the smaller of the size of the virtual disk or the calculated Read working data set; setting a size of a cache resource for writes at a desired margin over the calculated Write data set; and setting a size of a cache resource for reads at a hit rate times calculated Read data set; operating, by the processor, the data center and measuring data regarding operating parameters of read and write workflows in the data center; and analyzing, by the processor, the data regarding the operating parameters to identify any bottlenecks in a storage and network configuration of a virtual machine and a network connection between a virtual machine and memory.

According to various further embodiments, an apparatus for providing life cycle management of memory resources in a data center containing a plurality of virtual machines is disclosed comprising: a computing system comprising one or more hosts in one or more clusters for hosting the virtual machines; at least one non-volatile memory that the virtual machines can write data to and read data from; a management server configured to: procure one or more storage devices for each virtual machine by, for each virtual machine: measuring, by the processor, the total amount of data written and read by the virtual machine over a specified sizing interval; calculating a Write working data set that is the total amount of data written to memory by the virtual machine over a specified sizing interval; calculating a Read working data set that is the total amount of data accessed by the virtual machine from persistent storage over the sizing interval; determining whether the Read working data set is greater than either an actual resource usage by the virtual machine or a size of a virtual disk associated with the virtual machine and, if so, set the Read working data set to be the size of the smaller of the size of the virtual disk or the calculated Read working data set times a hit rate; setting a size of a cache resource for writes at a desired margin over the calculated Write data set; and setting a size of a cache resource for reads at a hit rate times calculated Read data set; operate the data center and measure data regarding operating parameters of read and write workflows in the data center; and analyze the data regarding the operating parameters to identify any bottlenecks in memory accessed by a virtual machine and a network connection between a virtual machine and memory.

According to various still further embodiments, a non-transitory computer readable storage medium having embodied thereon instructions for causing a computing device to perform a method of life cycle management of memory resources in a data center containing a plurality of virtual machines running on one or more hosts in one or more clusters is disclosed, the method comprising: procuring, by a processor, one or more storage devices for each virtual machine by, for each virtual machine: measuring, by the processor, the total amount of data written and read by the virtual machine over a specified sizing interval; calculating, by the processor, a Write working data set that is the total amount of data written to memory by the virtual machine over the specified sizing interval; calculating, by the processor, a Read working data set that is the total amount of data accessed by the virtual machine from persistent storage over the sizing interval; determining, by the processor, whether the Read working data set is greater than either an actual resource usage by the virtual machine or a size of a virtual disk associated with the virtual machine and, if so, setting the Read working data set to be the size of the smaller of the size of the virtual disk or the calculated Read working data set; setting a size of a cache resource for writes at a desired margin over the calculated Write data set; and setting a size of a cache resource for reads at a hit rate times calculated Read data set; operating, by the processor, the data center and measuring data regarding operating parameters of read and write workflows in the data center; and analyzing, by the processor, the data regarding the operating parameters to identify any bottlenecks in a storage and network configuration of a virtual machine and a network connection between a virtual machine and memory.

### BRIEF DESCRIPTION OF THE DRAWINGS

FIG. 1 is a block diagram of a portion of a data center operating environment in which various embodiments can be practiced.

FIG. 2 is a simplified flowchart of a method of the present invention according to one embodiment.

FIG. 3 shows a set of determinations that may be made as to whether there are any bottlenecks in the system based upon observed data for VMs that are accelerated by server side caching.

FIG. 4 shows a set of determinations that may be made when a bottleneck in a SAN appears to be a problem.

FIG. 5 shows a set of determinations that may be made when a bottleneck in a network appears to be a problem.

FIG. 6 shows a set of determinations that may be made when a bottleneck in a flash memory appears to be a problem.

FIG. 7 shows a set of determinations that may be made as to whether there are any bottlenecks in the system based upon observed data for VMs that are not accelerated by server side caching.

FIG. 8 is a simplified flowchart of a method according to one embodiment for determining whether a write pattern is bursty.

FIGS. 9 to 12 are example reports of some of the graphs of system metrics that may be displayed to a user through a graphical user interface.

### DETAILED DESCRIPTION

The present application describes a system that provides life cycle management of virtualized storage performance. The storage life cycle generally consists of the steps of procurement, operation and analysis, reporting of results, and implementation of recommendations. The system described herein can provide comprehensive information to a user for each one of these phases, in a manner that supports different types of storage technologies within virtualized environments.

To aid users of the system in procurement, the system analyzes current virtualized workloads and provides working set estimates for individual VMs, hosts, and clusters. The working set estimate data is then utilized to make specific recommendations for different types of backend storage technologies. Additionally the system contains detailed workload data (e.g. read/write, block sizes) that are important to take into account when choosing the right storage system/technology. The overall data set also helps the user determine the relative weights of VMs and hosts in terms of storage performance.

After procuring a storage device, the system provides a variety of information to aid in the operation of the system. This includes analysis of the read and write workflows utilizing context-specific and progressive disclosure of data to allow the user to understand and use storage performance data. This includes both storage performance metrics such as TOPS, bandwidth and latency, as well as detailed workload data including read/write mix and IO block sizes.

From this information, the system can detect various scenarios and proactively make recommendations to the user about ways in which to improve storage performance at a host level and at a per-VM level. In some embodiments, these recommendations may be implemented automatically without user involvement.

Lastly the system can provide a mechanism to generate an evaluative report that summarizes virtualized storage performance over a designated time period. The report can summarize the storage-related performance of virtual machines, hosts, clusters, and the underlying storage system, and can also be used to feed back into the procurement phase and start the cycle over again.

In a typical VM environment, there is a data center that is organized as one or more clusters of hosts; each host in a cluster runs one or more virtual machines. All data from VMs is read from and/or written to a shared storage system or array. A management server component may be deployed either as another VM in one of the clusters in the data center, or on separate physical hardware outside of the clusters.

An agent on each host in a cluster provides monitoring of the hosts and virtual machines. The agent monitors all input and output data from the VMs running on that host. The agent collects configuration and performance statistical data and sends it to the management server, which processes the data and prepares it for presentation to the user. Reports can be made at any desired level, such as the host level, cluster level, etc.

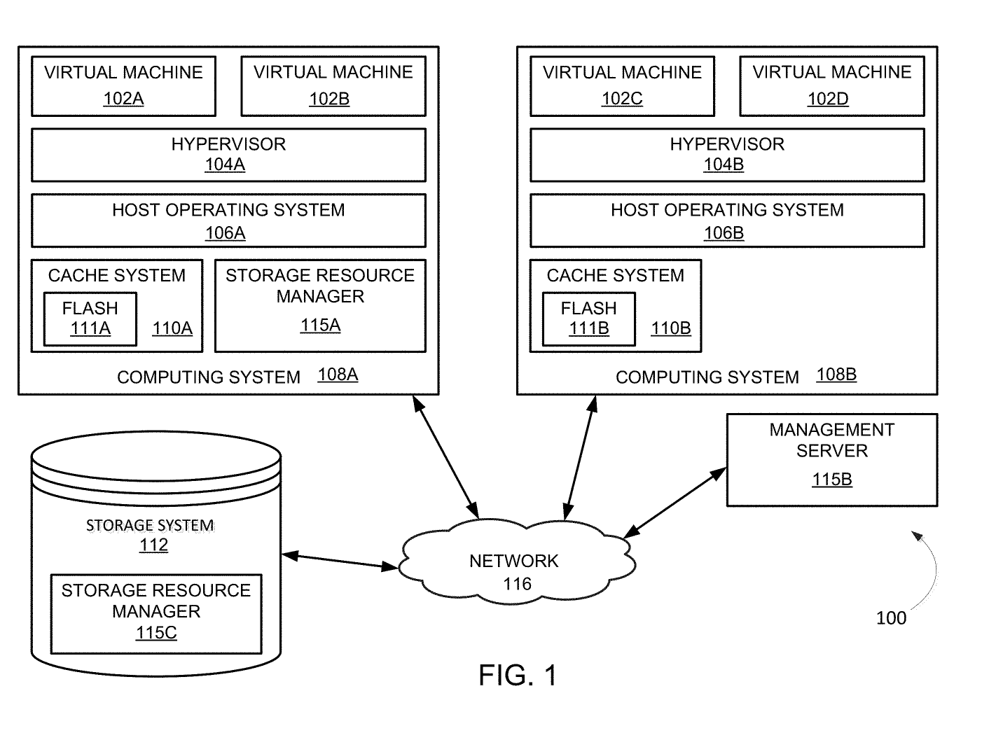

FIG. 1 is a block diagram of a portion of a data center environment 100 in which various embodiments can be practiced. Referring first to host computing system 108A on the left, the environment 100 comprises one or more virtual machines 102 (denoted 102A & 102B in the figure, and wherein each virtual machine can itself be considered an application) executed by a hypervisor 104A. The hypervisor 104A is executed by a host operating system 106A (which may itself include the hypervisor 104A) or may execute in place of the host operating system 106A. The host operating system 106A resides on the physical computing system 108A; in this embodiment, the computing system 108A has a cache system 110A.

The illustrated cache system 110A is known as a “server-side” cache and includes operating logic to cache data within a local memory. Server-side caching is a method that attempts to move commonly accessed data closer to the host. The local memory is a faster, more expensive memory such as Dynamic Random Access Memory (DRAM) or persistent devices such as flash memory 111A. One example of such server-side caching is the FVP product from PernixData, now part of Nutanix, Inc., of San Jose, Calif.

The environment 100 can include multiple computing systems 108, as is indicated in the figure by computing system 108A and computing system 108B. Each of computing system 108A and 108B is configured to communicate across a network 116 with a storage system 112 to store data. Network 116 is any known communications network including a local area network, a wide area network, a proprietary network or the Internet. The storage system 112 is a slower memory device such as a Solid State Drive (SSD) or hard disk. The environment 100 can include multiple storage systems 112. Examples of storage system 112 include, but are not limited to, a storage area network (SAN), a local disk, a shared serial attached “small computer system interface (SCSI)” (SAS) box, a network file system (NFS), a network attached storage (NAS), an internet SCSI (iSCSI) storage system, and a Fibre Channel storage system. Storage system 112 is hereafter referred to as a SAN.

Referring to either of computing system 108A or 108B, when a virtual machine 102 generates a read command or a write command, the application sends the generated command to the host operating system 106. The virtual machine 102 includes, in the generated command, an instruction to read or write a data record at a specified location in the SAN 112 that is part of a “virtual disk” associated with the particular virtual machine 102. When activated, cache system 110 receives the sent command and caches the data record and the specified SAN memory location. As understood by one of skill in the art, in a write-through cache system, the generated write commands are simultaneously sent to the SAN 112. Conversely, in a write-back cache system, the generated write commands are subsequently sent to the SAN 112 typically using what is referred to herein as a destager.

In some embodiments of the present approach, and as would be understood by one of skill in the art in light of the teachings herein, the environment 100 of FIG. 1 can be further simplified to being a computing system running an operating system running one or more applications that communicate directly or indirectly with the SAN 112.

As stated above, cache system 110 includes various cache resources. In particular and as shown in the figure, cache system 110 includes a flash memory resource 111 (e.g., 111A and 111B in the figure) for storing cached data records. Further, cache system 110 also includes network resources for communicating across network 116.

Such cache resources are used by cache system 110 to facilitate normal cache operations. For example, virtual machine 102A may generate a read command for a data record stored in SAN 112. As has been explained and as understood by one of skill in the art, the data record is received by cache system 110A. Cache system 110A may determine that the data record to be read is not in flash memory 111A (known as a “cache miss”) and therefore issue a read command across network 116 to SAN 112. SAN 112 reads the requested data record and returns it as a response communicated back across network 116 to cache system 110A. Cache system 110A then returns the read data record to virtual machine 102A and also writes or stores it in flash memory 111A (in what is referred to herein as a “false write” because it is a write to cache memory initiated by a generated read command versus a write to cache memory initiated by a generated write command which is sometimes referred to herein as a “true write” to differentiate it from a false write).

Having now stored the data record in flash memory 111A, cache system 110A can, following typical cache operations, now provide that data record in a more expeditious manner for a subsequent read of that data record. For example, should virtual machine 102A, or virtual machine 102B for that matter, generate another read command for that same data record, cache system 110A can merely read that data record from flash memory 111A and return it to the requesting virtual machine rather than having to take the time to issue a read across network 116 to SAN 112, which is known to typically take longer than simply reading from local flash memory.

Likewise, as would be understood by one of skill in the art in light of the teachings herein, virtual machine 102A can generate a write command for a data record stored in SAN 112 which write command can result in cache system 110A writing or storing the data record in flash memory 111A and in SAN 112 using either a write-through or write-back cache approach.

Still further, in addition to reading from and/or writing to flash memory 111A, in some embodiments cache system 110A can also read from and/or write to flash memory 111B and, likewise, cache system 110B can read from and/or write to flash memory 111B as well as flash memory 111A in what is referred to herein as a distributed cache memory system. Of course, such operations require communicating across network 116 because these components are part of physically separate computing systems, namely computing system 108A and 108B.

In one embodiment, a management server 115A is configured to generate performance utilization values for one or more SAN 112 and perform system management actions according to the performance utilization values. The management server 115A can be implemented in a variety of ways known to those skilled in the art including, but not limited to, as a software module executing within computing system 108A. The software module may execute within an application space for host operating system 106A, a kernel space for host operating system 106A, or a combination thereof.

Alternatively, management server 115A may instead execute as an application within a virtual machine 102. In another embodiment, management server 115A may be replaced by management server 115B, configured to execute in a computing system that is independent of computing systems 108A and 108B. In still another embodiment, management server 115A may be replaced by management server 115C, configured to execute within a SAN 112. It will be apparent that in each of these embodiments, the functions of management server 115 will be performed by a computing device or processor.

In one embodiment, management server 115 includes three sub-modules. A first of the three sub-modules is a data collection system, configured to provide raw usage statistics data for usage of the SAN 112. For example, the raw usage statistics data can include input/output operations per second (IOPS) performed for read and write I/O request block sizes and workload profiles (accumulated I/O request block size distributions). In one embodiment, a portion of the first sub-module is configured to execute within SAN 112 to collect raw usage statistics related to storage resource usage, and a second portion of the first sub-module is configured to execute within computing systems 108 to collect raw usage statistics related to virtual machine resource usage.

The second sub-module is configured to calculate performance utilization, such as performance utilization of the SAN. As above, in one embodiment the second sub-module is implemented to execute within management server 115 in a computing system 108 (in management server 115A), in an independent computing system (in management server 115B) or in SAN 112 (in management server 115C). The third sub-module is configured to receive performance utilization output results of the second sub-module, and to respond to the utilization output results by directing a system management action as described further elsewhere herein.

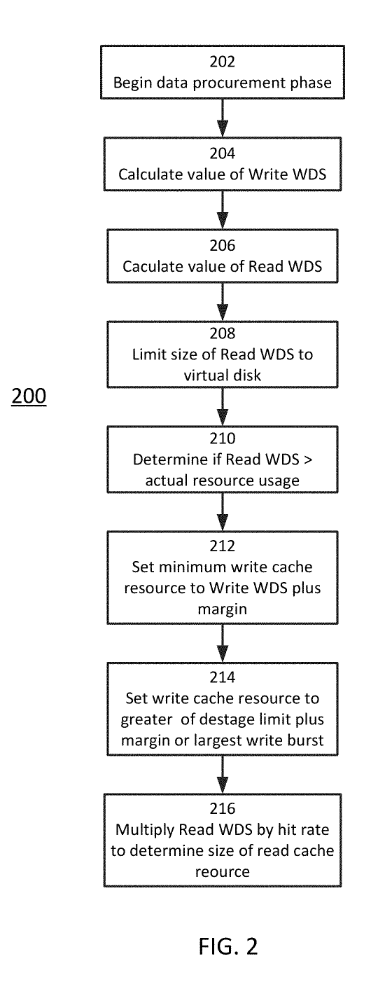

FIG. 2 is a simplified flowchart of a method that is performed by the management server 115 according to one embodiment. The method described herein begins at step 202 with a procurement phase in which management server 115 estimates two working data sets (“WDSs”) for each VM or application. The WDSs are used by management server 115 to recommend appropriate sizes for the cache resources in order to accelerate reads and writes for all VMs on a host.

One WDS is a Read WDS, and the other is a Write WDS. The Read WDS is defined as the total amount of data accessed from a persistent storage (such as SAN 112 of FIG. 1) by the VM in a given time period, or “sizing interval,” while the Write WDS is the total amount of data written to the persistent storage in the sizing interval.

Data accessed includes first time access as well as repeated access, while data written includes writes to unique locations as well as repeated writes to the same location. The time period used to determine the WDSs may be selected, but the period should be long enough to perform reasonable data sampling. In some embodiments an 8-hour window will be considered reasonable for practical purposes as this will typically be equivalent to a normal business day. It will be apparent that it will be beneficial to choose a window that includes the period of most activity; in certain applications, such as databases, care should be taken that the WDSs are not measured during periods of abnormal activity, i.e., the period of database backup. It may also be desirable to perform multiple instances of such data sampling. For example, 21 sets of data may be obtained by performing data sampling over three 8-hour periods each day for one week; this allows for a good representation of variance in the workload to be obtained. A median value of the samples may then be obtained, and is more likely to be representative of a real workload if there is such variance.

To determine the Write WDS, at step 204 management server 115 measures all of the data written during the sizing interval. This is typically accomplished by dividing the sizing interval into sampling intervals, measuring the data written during each sampling interval, and then summing the measured data. For example, a sizing interval of 8 hours might be divided into sampling intervals of 20 seconds each. Data is typically written in “buckets,” each bucket containing “blocks” of various sizes, for example, 4 kilobytes, 8 kilobytes, etc. Thus, the size of the Write WDS may be represented as the sum of all the samples including the sum of all block sizes:

$${\sum }_{sample = 1}^{sample = n} ( {\sum }_{BS = 512 Bytes}^{BS = Max} ( block size \times bucket count ) )$$

where BS is the block size.

Determination of the Read WDS involves several steps. At step 206, management server 115 calculates a value of the Read WDS in a similar fashion to the Write WDS above, using the same formula above applied to reads rather than writes. However, it is assumed from experience that 50% of the reads are repeats. Thus, the size of the Read WDS will be 50% of amount calculated using the formula above. One of skill in the art will appreciate that a different percentage may be used if desired.

Even with the assumption above that 50% of the reads are repeats, the Read WDS may exceed the size of the virtual disk; this is because all of the data read in the sizing interval is counted, and if the interval is too long most of the read access will be repeat access. Thus, in a next step 208, it is assumed that the size of the Read WDS cannot exceed the size of the virtual disk associated with a particular VM, so that if the value of the Read WDS calculated for a particular VM as above would be larger than the associated virtual disk, then the size of the Read WDS is set to the size of the virtual disk.

Once management server 115 has determined the Read WDS and Write WDS sizes as above, it then uses those sizes to determine a desired size of the cache resources, i.e., the size of the cache memory devices (e.g., DRAM or flash memory). The total cache resource size is the total of the resource needed for the Write WDS and that needed for the Read WDS. An estimate of the resource size is partly based upon the hit rate and the destage limit for the system.

Management server 115 next determines the size of the cache resource for writes at step 212. It is desirable to allow for the largest burst of data written to be kept in the cache until the data can be destaged to SAN 112; once the data has been destaged and saved in SAN 112, it will also remain in the cache until there is pressure for space to accommodate new data. At that time, in one embodiment, data is removed from the cache, or “evicted,” under a Least Recently Used (LRU) policy familiar to those of skill in the art.

However, the cache resource must also contain enough space so that when data is evicted, data that is in the cache as a result of reads is not also evicted. As a starting point, extra space is thus provided in the cache resource to accommodate writes. In one embodiment, the cache resource is set to the greater of the maximum size of the write burst IO (again, for example, over 20 second data samples in an 8 hour window) or 125% of the destage limit.

The server side cache typically has a destage limit, i.e., it will hold a maximum amount of data that is yet to be destaged to the SAN 112; at step 212 the calculated Write WDS is multiplied by 125% to obtain the minimum size of the cache resource. For example, the PernixData FVP product has a destage limit of 8 gigabytes (GB). Thus, as a starting point, for the FVP product the minimum cache resource is 125% of 8 GB, or 10 GB.

Such an approach will generally be acceptable for desktop-class VMs, but in the case of enterprise class VMs the 25% of extra space may not be sufficient. Thus, another criteria to be applied is the largest write burst issued by the particular application, i.e., the largest amount of data written by the application in any of the samples taken as described above; in the description above, the samples are of 20 seconds each. For this reason, for a virtual machine with server side caching, at step 214 the size of the resource for the Write WDS is set to the greater of the destage limit (10 GB in the example of the PernixData FVP) or the largest write burst in any of the 20 second sampling periods. One of skill in the art will appreciate that it may be desirable to make the resource for the Write WDS even larger, for example, if the data is to be replicated on more than one storage device.

Lastly, management server 115 determines the size of the cache resource for reads at step 216. In order for management server 115 to determine the size of the cache resource for reads, an assumption about the hit rate should be made. The resource could be sized for a 100% hit rate (or close to that), but for workloads with a large Read WDS, this may require a very large resource. Thus, a hit rate of less than 100% (e.g., 90%) is typically assumed so that resource sizing can be more practical.

In some embodiments, it is thus assumed that the desired hit rate is 90%, i.e., the resource should be large enough to service 90% of read requests without having to access the SAN 112. Thus, the resource needed for the Read WDS is 90% of the size of the Read WDS, calculated as described above.

As above, in this embodiment and example, the total resource needed is thus 90% of the size of the Read WDS plus 10 GB or the size of the largest write burst in a 20 second period.

A recommendation engine (also part of management server 115) applies an algorithm to data collected from the system to analyze application performance; in one embodiment, the recommendation engine algorithm may be a rule-based decision tree. The collected data may include, for example: characteristics of the application or workload such as the read/write mix and I/O block sizes and patterns; characteristics of the storage such as latency, throughput and input/output operations per second (IOPS); and configurations of the datacenter, such as VM placements in the host and network configurations. The goal is to provide guidance to the user(s) on system operation and recommend and/or take specific actions that can improve performance or solve detected problems. The resource sizing recommendations discussed above may be made by the recommendation engine.

Once the resource size is established, the recommendation engine can find a variety of performance problems by analyzing operating parameters of the system and can make VM performance optimization recommendations. This can be done both for VMs that are accelerated by server side caching as discussed above and for VMs that are not so accelerated. In the examples of accelerated VMs that follow, some parameters are based upon the PernixData FVP product, but the principles can be applied to any system using server side caching.

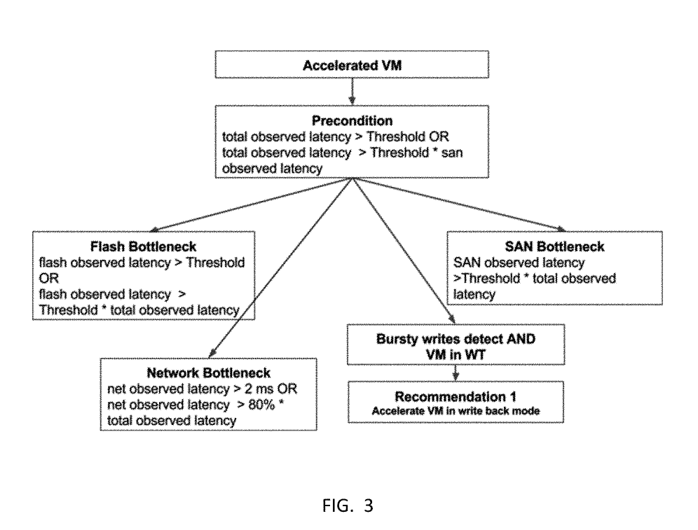

FIG. 3 shows a set of determinations that may be made as to whether there are any bottlenecks in the system based upon observed data for VMs that are accelerated by server side caching. At step 302 the recommendation engine makes a preliminary determination as to whether a VM warrants a further evaluation. If the total observed latency in the system exceeds a predefined threshold, or the threshold times a latency in the SAN, then the recommendation engine proceeds to further evaluation. For example, in the PernixData FVP product, the threshold may be a predefined value, such as 3 ms, or may be 80% of the SAN latency.

Where further evaluation is warranted, several possibilities are examined. These are whether bottlenecks exist in the SAN, the flash, or the network. The stated conditions in FIG. 3 indicate whether the recommendation engine proceeds to further analysis and makes recommendations depending upon the results of that analysis.

At step 304, the recommendation engine determines whether writes are occurring in a “bursty” way, i.e., data is not being written uniformly over time but in spurts, while the VM is writing data in write-through mode, i.e., data is written to SAN 112 immediately rather than destaged. If this is the case, at step 306 the recommendation engine makes a recommendation (“Recommendation 1”) that the VM should be accelerated in write-back mode rather than continuing to operate in write-through mode.

One of skill in the art will appreciate that there are various write patterns that may be considered “bursty,” and be able to determine whether the pattern is bursty in a given case. Where automatic detection of bursty writes is desired, it may be accomplished as described later herein.

At step 308 it is determined whether there is a bottleneck in the SAN and whether this appears to be the major contributing factor in the overall latency of the system. This is done by determining whether observed latency in the SAN is greater than a threshold times the total observed latency in the system. This may be the result of the SAN being slow or the network connection being slow. Again, for example, it may be determined whether total observed latency is greater than or equal to 80% of the SAN latency.

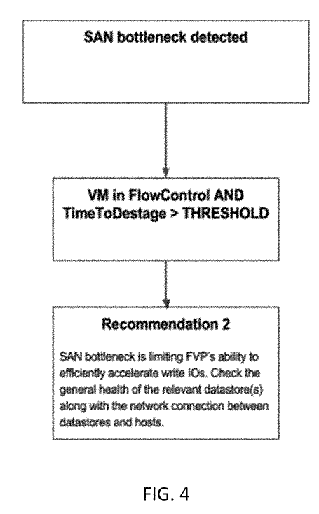

If the bottleneck in the SAN appears to be the major factor, then the recommendation engine tries to determine the cause. This is shown in FIG. 4. Since the VM is accelerated by server side caching as above, the VM latency should always track the flash latency, and not the SAN latency. At step 402 the VM is placed in “flow control”; if the time to destage still exceeds a threshold, then the SAN appears to be the bottleneck and is limiting the server side cache's ability to efficiently read and/or write.

In flow control, if the writeback caching mode cannot write fast enough to the SAN back-end storage, the incoming I) (reads/writes) are throttled so that the caching device does not become full. The recommendation engine may, for example, look to see if the VM's SAN latency is greater than or equal to 80% of the VM's total observed latency, and if flow control is applied to the VM. If both are true, then the SAN is considered to be the bottleneck in the system.

At step 404 Recommendation 2 is made to check the SAN and the network connection from the host to the SAN for problems.

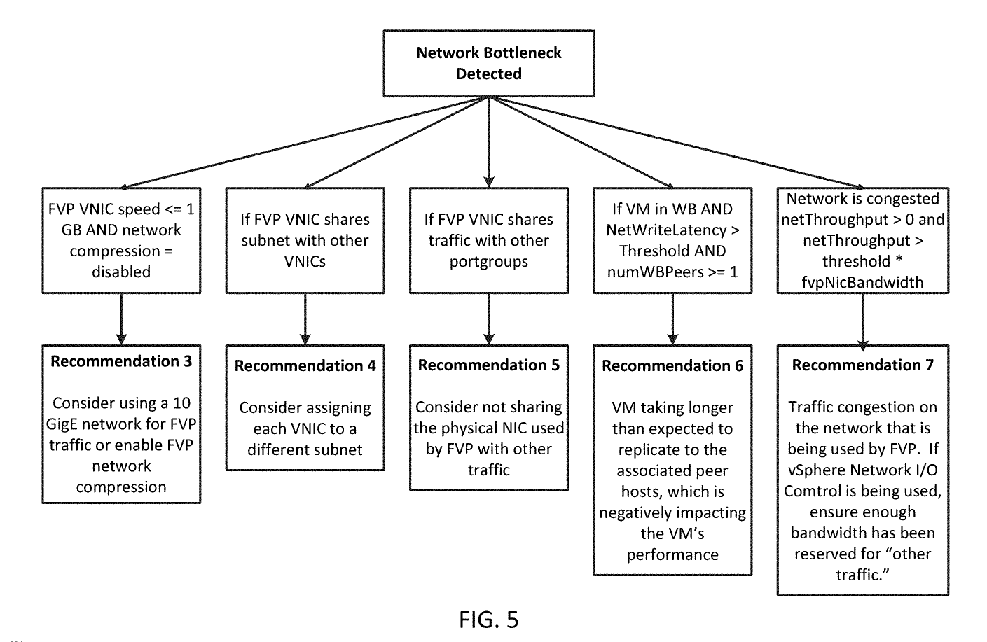

Returning to FIG. 3, at step 310 it is determined whether there appears to be a network bottleneck. In an embodiment, if the net observed latency exceeds 2 milliseconds (ms) or 80% of the total observed latency, then the recommendation proceeds to do further evaluation of a possible network bottleneck as shown in FIG. 5.

FIG. 5 shows a set of determinations that may be made when a bottleneck in the network appears to be a problem. Such a bottleneck is generally a write-back issue where data has not yet been destaged, i.e., writes are not considered “written” until they are written to all other configured hosts; it is possible that the network between hosts may be congested. The recommendation engine examines metrics related to write-back peers, and attempts to determine whether the number of other caching devices configured for replication needs to be changed.

In some embodiments, if the time for data writes takes too long, for example, more than 2 ms, or if the network latency is greater than or equal to 80% of the VM's total observed latency, the network may be considered to be a bottleneck. In such cases, a recommendation may be made to adjust the replication level, and a user may choose to reduce the number of peers to which data is to be replicated to 1 or even 0.

In the following discussion, the concept of a virtual network interface card, or “VNIC,” is used. The VNIC connects a VM to a virtual interface, and allows the VM to send and receive data.

At step 502, the recommendation engine checks to see if the speed of the VNIC is less than 1 gigabit per second and network compression is disabled. If so, at step 504 the recommendation engine makes Recommendation 3 that the user consider using a 10 gigabits/sec network and/or enabling network compression.

At step 506, the recommendation engine determines whether the VNIC shares a subnet with other VNICs. If so, at step 508 Recommendation 4 is made that the user consider assigning each VNIC to a separate subnet.

At step 510, the recommendation engine determines whether the VNIC shares traffic with other portgroups, i.e., portions of physical hosts which allow specific traffic to and from a VM. For example, one portgroup could handle only Vmotion traffic, while another portgroup handles management or control traffic. If a portgroup is assigned more than one responsibility, it may impact specific functions due to one type of network traffic overloading the portgroup. If this is the case, at step 512 the recommendation engine makes Recommendation 5 that the user consider not sharing the physical network interface card used by the server side cache with other traffic.

At step 514, the recommendation engine determines whether, when the VM is in write-back, the net write latency is greater than a threshold, for example, 2 ms, and the number of write-back peers is equal to or greater than 1. If so, at step 516 the recommendation engine makes Recommendation 8 to advise the user that the VM is taking longer than expected to replicate data to the associated peer hosts, which is negatively impacting the performance of the VM.

At step 518, the recommendation engine determines whether the network is congested by determining that net throughput is greater than a specified percentage of the physical network interface card bandwidth. If this is the case, at step 520 the recommendation engine makes Recommendation 9 to advise the user that there is traffic congestion on the network, and that adequate bandwidth should be reserved for other traffic on the network.

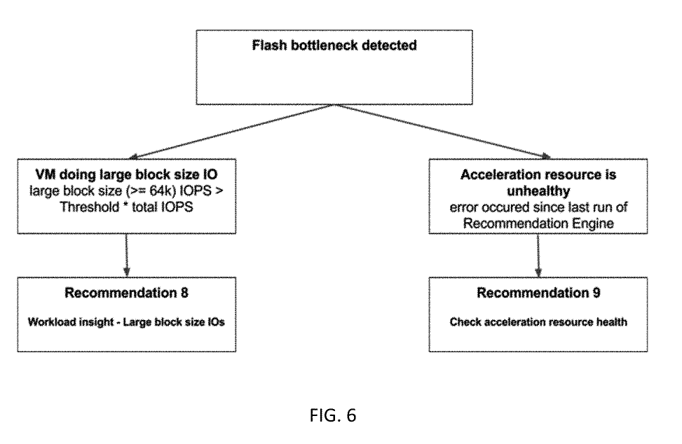

Returning again to FIG. 3, at step 312 the recommendation engine determines whether there appears to be a flash bottleneck, by determining whether the observed flash latency exceeds a threshold, for example, 1 ms, or is greater than a predefined portion, such as 80%, of the total observed latency of the system. If there appears to be a flash bottleneck, further evaluation is performed as in FIG. 6.

FIG. 6 shows a set of determinations that may be made when a bottleneck in the flash appears to be a problem. In an accelerated VM, it is expected that the VM latency should be as close to the flash latency as possible, and lower than the SAN latency. If the flash latency is too high, this can create a bottleneck.

At step 602 the recommendation engine checks to see if the problem is that the VM is doing I/O operations with large block sizes, which can create a bottleneck if the flash memory is not of high throughput. If the IOPS with large blocks, for example, blocks over 64 kilobytes, is greater than a specified percentage of the total IOPS, then the recommendation engine can make Recommendation 8 at step 604, suggesting that a higher throughput memory, such as RAM or flash of higher throughput, may deliver increased performance. RAM will obviously be faster, and is often able to better handle large blocks.

At step 606, the recommendation engine determines whether there has been an error since the last check of the acceleration resource, i.e., the server side cache; if there are numerous failures of the flash memory, the flash latency will increase. If there appear to be such errors, at step 608 the recommendation engine may make Recommendation 9 that the health of the server side cache, including the resource allocation in the flash, be checked.

For accelerated VMs as discussed above with respect to FIGS. 3 through 6, the recommendation engine focus is on bottlenecks in the resource. In the case of unaccelerated VMs, the focus is on solutions to improve performance by considering the characteristics of the workload.

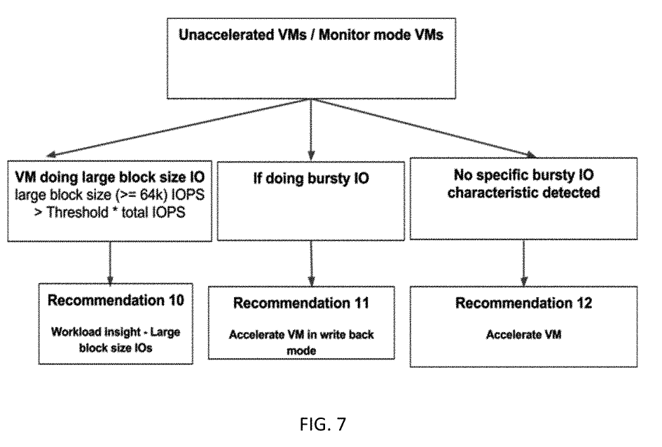

FIG. 7 shows a set of determinations that may be made as to whether there are any bottlenecks in the system based upon observed data for VMs that are not accelerated by server side caching.

At step 702 the recommendation engine checks to see if the problem is that the VM is doing I/O operations with large block sizes, which can create a bottleneck. This is similar to the situation regarding accelerated VMs described above with respect to FIG. 6, except now the problem is not the throughput of the flash memory. Again, if the TOPS with large blocks, for example, blocks over 64 kilobytes, is greater than a specified percentage of the total IOPS, then the recommendation engine can make Recommendation 10 at step 704, advising the user that the workload contains large block size I/O operations. This does not necessarily mean that the I/O operations are causing latency issues, so latencies corresponding to the IOPS of the large block sizes are also considered. Based on this information, a user can then examine the workload and the applications issuing such I/O operations, and consider changing the workload by tuning the application.

The recommendation engine also looks at the I/O patterns of the applications to consider whether acceleration will provide improvement, and may be able to recommend specific server side caching policies that can be used, such as write through or write back.

At step 706, the recommendation engine determines whether writes are occurring in a “bursty” way, similar to step 304 in FIG. 3 above. If this is the case, at step 708 the recommendation engine makes Recommendation 11 that the VM should be accelerated in write-back mode, again similar to Recommendation 1 in FIG. 3.

At step 710, if the recommendation engine determines that there is no specific bursty I/O pattern, then in step 712 the recommendation engine may provide Recommendation 12 to accelerate the VM by providing server side caching, but without suggesting write-back mode.

In some embodiments, the recommendation engine may update its recommendations periodically, for example every hour. It will most likely be preferable to make recommendations for each VM separately, but this is not required.

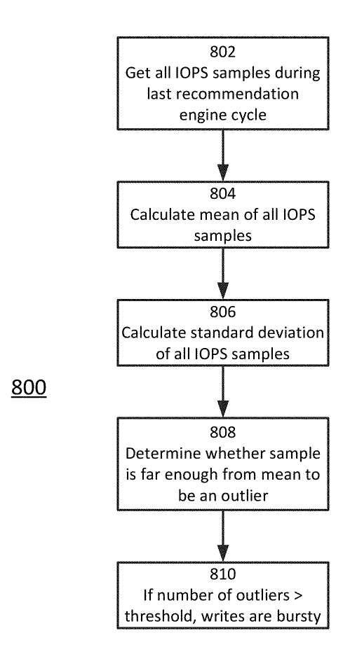

As above, a recommendation engine may automatically determine whether a particular write pattern is bursty, e.g., as in step 706 in FIG. 7. FIG. 8 is a flowchart of one method 800 that may be performed automatically by the recommendation engine.

At step 802, all of the write IOPS sampled during the last recommendation engine cycle (one hour in the example above) are obtained. The mean of all of the samples is calculated at step 804, and the standard deviation of all the samples calculated at step 806.

At step 808, the recommendation engine determines for each sample whether the sample is an “outlier” that is farther away from the mean than a selected threshold. In one embodiment, a sample that is more than 1.5 times the standard deviation away from the mean is classified as an outlier. Finally, at step 810, the recommendation engine determines whether the number of outliers exceeds a certain threshold; it there are more outliers than the threshold, the VM is determined to be operating in a bursty write pattern.

As above, the system can have the ability to generate a report that summarizes performance of the virtualized storage. The report may be presented through a graphical user interface on a host machine, and may summarize the storage-related performance of virtual machines, hosts, clusters, and the underlying storage system. For example, data may be presented regarding such metrics as the rate of I/O or IOPS, the rate of data reads and writes, throughput and/or latency.

The report can further provide a variety of breakdowns of these metrics as may be desired by the user(s). For example, data may be broken down by reads, storage reads, network reads, writes, storage writes, network writes, and/or block sizes. Additionally, the report and/or the graphical user interface may also present the various recommendations discussed above.

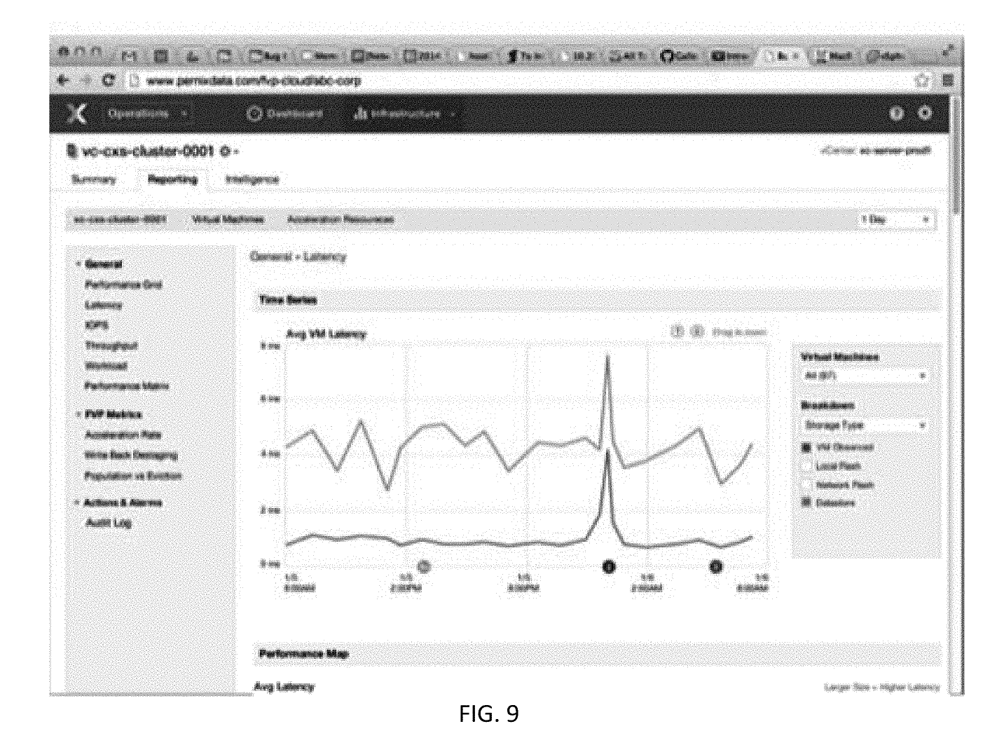

FIGS. 9 to 12 are example reports of some of the graphs of system metrics that may be displayed to a user through a graphical user interface. FIG. 9 is a graph of the average measured latency over time in a system, both in the virtual machines and in the storage system.

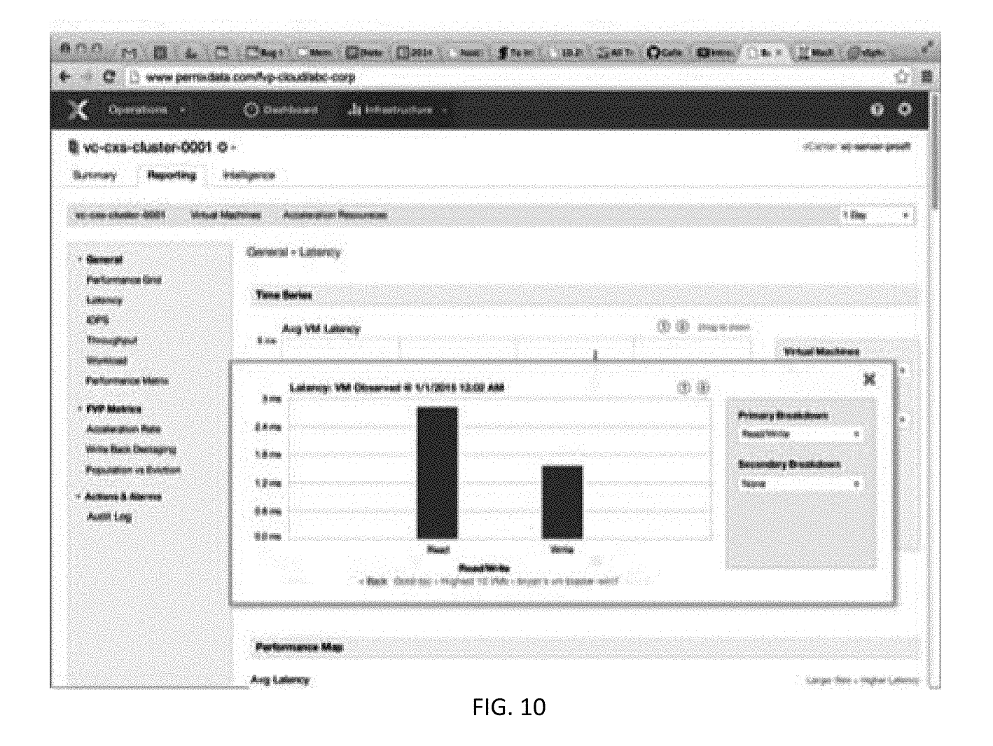

FIG. 10 is a graph of the average latency observed at a particular time in the 10 virtual machines having the highest latency, specified by reads and writes.

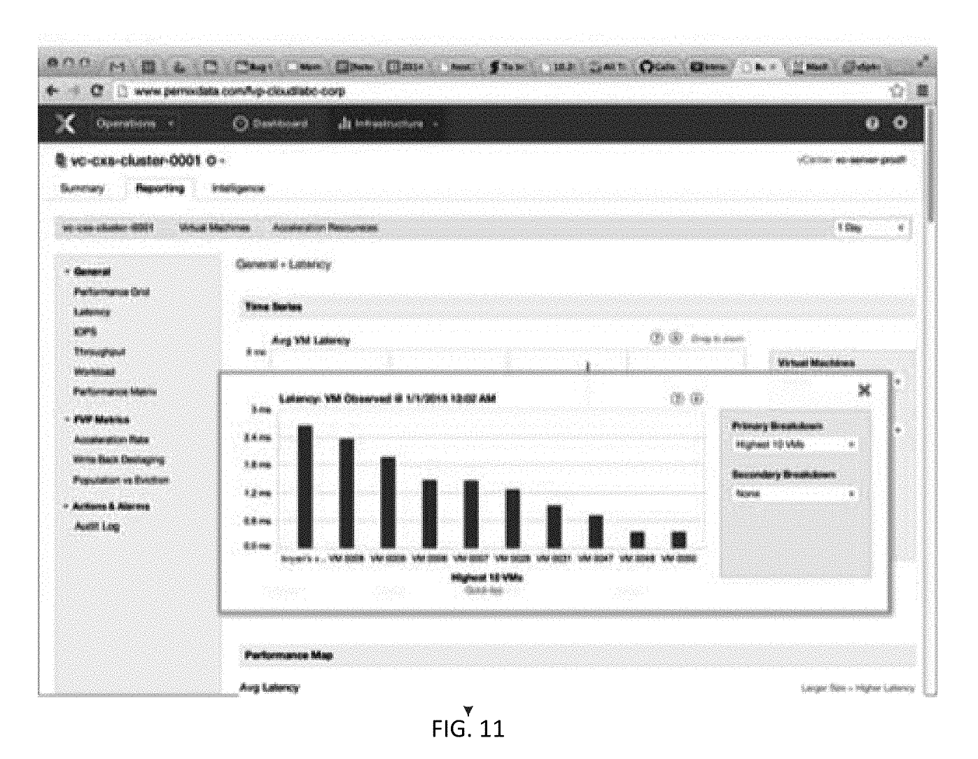

FIG. 11 is a graph of the latency observed at a particular time in the 10 virtual machines having the highest latency, for each individual virtual machine.

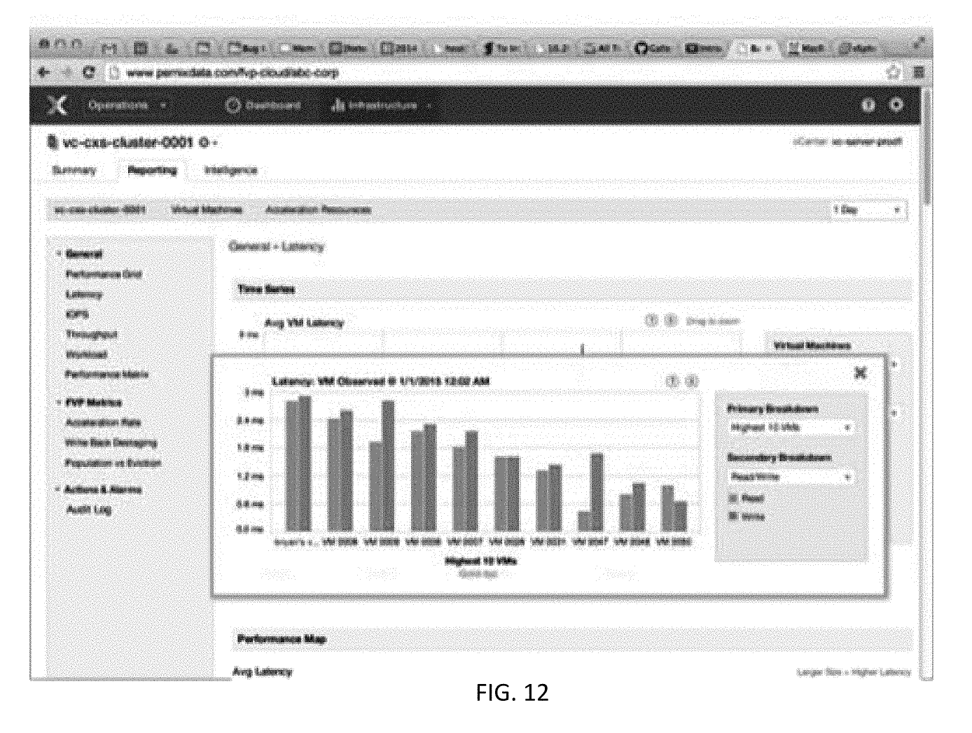

FIG. 12 is a further breakdown of the graph of FIG. 11, showing the latency observed at a particular time in the 10 virtual machines having the highest latency, and separating read and write latency for each individual virtual machine.

One of skill in the art will appreciate that any metric that can be measured in a system containing virtual machines, including, but not limited to, those described above, can be presented to the user(s) as desired. This can be done through a graphical user interface, as shown in FIGS. 9 to 12 above, or may alternatively be presented in a report in any desired format, including text, spreadsheet, presentation slide, or other formats.

In some embodiments, the recommendation engine may be configured to implement some or all of the recommendations automatically, without affirmative user action. For example, where all the necessary memory resources are present, the recommendation engine may, for example, enable server side caching, adjust the size of the data resources, etc.

One of skill in the art will appreciate that it is desirable to base the recommendations and decisions regarding operation of the system described herein on current statistics. Thus, in some embodiments, the method of the present invention will repeat periodically so that the described metrics may be updated and recommendations made or renewed based on current data. At the beginning of each such subsequent period, the described report can be used to feed back into the procurement phase and start the cycle over again.

The present application thus presents techniques for determining the appropriate cache resources for use in virtual machines, and for detecting and ameliorating bottlenecks in memory accessed by the virtual machines or the network(s) used to connect a virtual machine to memory.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or processors, computing system or logic circuits, perhaps more complex than those described herein, may be used, and possibly different types of memory in either the cache system or the storage area network.

As noted herein, various other variations are possible, such as the location of the management server, and the type of network connecting a virtual machine to a storage area network.

It should also be appreciated that the described method and apparatus can be implemented in numerous ways, including as a process, an apparatus, or a system. The methods described herein may be implemented by program instructions for instructing a processor to perform such methods, and such instructions recorded on a computer readable storage medium such as a hard disk drive, floppy disk, optical disc such as a compact disc (CD) or digital versatile disc (DVD), flash memory, etc., or a computer network wherein the program instructions are sent over optical or electronic communication links. Such program instructions may be executed by means of a processor or controller, or may be incorporated into fixed logic elements. It should be noted that the order of the steps of the methods described herein may be altered and still be within the scope of the disclosure.

These and other variations upon the embodiments are intended to be covered by the present disclosure, which is limited only by the appended claims.

What is claimed is:

1. A method of life cycle management of memory resources in a data center containing a plurality of virtual machines running on one or more hosts in one or more clusters, comprising:
procuring, by a processor, one or more storage devices for each virtual machine by, for each virtual machine:
measuring, by the processor, the total amount of data written and read by the virtual machine over a specified sizing interval;
calculating, by the processor, a Write working data set that is the total amount of data written to memory by the virtual machine over the specified sizing interval;
calculating, by the processor, a Read working data set that is the total amount of data accessed by the virtual machine from persistent storage over the sizing interval;
determining, by the processor, whether the Read working data set is greater than either an actual resource usage by the virtual machine or a size of a virtual disk associated with the virtual machine and, if so, setting the Read working data set to be the size of the smaller of the size of the virtual disk or the calculated Read working data set;
setting a size of a cache resource for writes at a desired margin over the calculated Write data set; and
setting a size of a cache resource for reads at a hit rate times calculated Read data set;
operating, by the processor, the data center and measuring data regarding operating parameters of read and write workflows in the data center; and
analyzing, by the processor, the data regarding the operating parameters to identify any bottlenecks in a storage and network configuration of a virtual machine and a network connection between a virtual machine and memory.

2. The method of claim 1 wherein the data measured by the processor comprises input/output operations per second, bandwidth and/or latency of storage or cache accessed by each virtual machine.

3. The method of claim 1 further comprising providing, by the processor, one or more recommendations for resolving any identified bottlenecks.

4. The method of claim 3 further comprising automatically implementing, by the processor, the one or more recommendations.

5. The method of claim 1 further comprising repeating, by the processor, at regular intervals the steps of:
procuring one or more storage devices for each virtual machine;
operating the data center and measuring data regarding operating parameters; and
analyzing the data regarding the operating parameters to identify any bottlenecks.

6. The method of claim 1, further comprising outputting, by the processor, instructions to a display device to display some or all of the measured data regarding operating parameters of read and write workflows in the data center.

7. The method of claim 3, further comprising outputting, by the processor, instructions to a display device to display some or all of the one or more recommendations for resolving any identified bottlenecks.

8. An apparatus for providing life cycle management of memory resources in a data center containing a plurality of virtual machines, comprising:
a computing system comprising one or more hosts in one or more clusters for hosting the virtual machines;
at least one non-volatile memory that the virtual machines can write data to and read data from;
a management server configured to:
procure one or more storage devices for each virtual machine by, for each virtual machine:
measuring, by the processor, the total amount of data written and read by the virtual machine over a specified sizing interval;
calculating a Write working data set that is the total amount of data written to memory by the virtual machine over a specified sizing interval;
calculating a Read working data set that is the total amount of data accessed by the virtual machine from persistent storage over the sizing interval;
determining whether the Read working data set is greater than either an actual resource usage by the virtual machine or a size of a virtual disk associated with the virtual machine and, if so, set the Read working data set to be the size of the smaller of the size of the virtual disk or the calculated Read working data set times a hit rate;
setting a size of a cache resource for writes at a desired margin over the calculated Write data set; and
setting a size of a cache resource for reads at a hit rate times calculated Read data set;
operate the data center and measure data regarding operating parameters of read and write workflows in the data center; and
analyze the data regarding the operating parameters to identify any bottlenecks in memory accessed by a virtual machine and a network connection between a virtual machine and memory.

9. The apparatus of claim 8 wherein the data measured by the management server comprises input/output operations per second, input/output block size distribution, bandwidth and/or latency of memory accessed by the virtual machine.

10. The apparatus of claim 8 wherein the management server is further configured to provide one or more recommendations for resolving any identified bottlenecks.

11. The apparatus of claim 10 wherein the management server is further configured to automatically implement the one or more recommendations.

12. The apparatus of claim 8 wherein the management server is further configured to repeatedly, at regular intervals:
procure one or more storage devices for each virtual machine;
operate the data center and measuring data regarding operating parameters; and
analyze the data regarding the operating parameters to identify any bottlenecks.

13. The apparatus of claim 8, wherein the management server is further configured to generate instructions to a display device to display some or all of the measured data regarding operating parameters of read and write workflows in the data center.

14. The apparatus of claim 10, wherein the management server is further configured to generate instructions to a display device to display some or all of the one or more recommendations for resolving any identified bottlenecks.

15. A non-transitory computer readable storage medium having embodied thereon instructions for causing a computing device to perform a method of life cycle management of memory resources in a data center containing a plurality of virtual machines running on one or more hosts in one or more clusters, the method comprising:
procuring, by a processor, one or more storage devices for each virtual machine by, for each virtual machine:
measuring, by the processor, the total amount of data written and read by the virtual machine over a specified sizing interval;
calculating, by the processor, a Write working data set that is the total amount of data written to memory by the virtual machine over the specified sizing interval;
calculating, by the processor, a Read working data set that is the total amount of data accessed by the virtual machine from persistent storage over the sizing interval;
determining, by the processor, whether the Read working data set is greater than either an actual resource usage by the virtual machine or a size of a virtual disk associated with the virtual machine and, if so, setting the Read working data set to be the size of the smaller of the size of the virtual disk or the calculated Read working data set;
setting a size of a cache resource for writes at a desired margin over the calculated Write data set; and
setting a size of a cache resource for reads at a hit rate times calculated Read data set;
operating, by the processor, the data center and measuring data regarding operating parameters of read and write workflows in the data center; and
analyzing, by the processor, the data regarding the operating parameters to identify any bottlenecks in a storage and network configuration of a virtual machine and a network connection between a virtual machine and memory.
